(19) United States
(12) Patent Application Publication
(10) Pub. No.: US 2014/0285295 A1
(43) Pub. Date: Sep. 25, 2014

(54) In-Surface Magnetic Mounting System

(71) Applicant: Oke Fred Liimatta, Fredericksburg, VA (US)

(72) Inventor: Oke Fred Liimatta, Fredericksburg, VA (US)

(21) Appl. No.: 13/849,382

(22) Filed: Mar. 22, 2013

(51) Int. Cl. H01F 7/02

(52) U.S. Cl. CPC H01F 7/0252
USPC 335/285

(57) ABSTRACT

A method of removably mounting objects on a surface by embedding a magnet in the surface and securing it in place either of the following: providing a hollow insert which frictionally engages both the magnet and the surface, providing a restraining material which once affixed to the surface prevents the magnet from being dislodged, or affixing the magnet into the surface by means of a filler material. Means have also been provided to improve the mounting performance for different types of objects, including the following magnetically responsive tags which once affixed to the object increase its overall magnetism and including features on said magnetically responsive tags that engage with either the magnet installation directly or with engagement articles affixed to the surface in the vicinity of the installed magnet.

### TECHNICAL FIELD

This application relates to methods of hanging objects.

### BACKGROUND ART

There do exist on the market today magnetic key holders such as the Umbra Magnetter Wall-Mount Organizer which allow the user to removably mount a few sets of keys on the surface of the organizer. Another commercially available product is the Cloud Key holder, which also holds a small number of objects. Both of these products require careful and tedious installation of screws appropriately spaced in order to mount them in the first place. These screws or nail heads must also be very level in order for the installed key holders to look good. Furthermore, the aesthetic designs of both of these units are geared towards a very specific look and will not fit in with the interior decorating style of every home. Neither of these designs work at all for surfaces that don't have enough room for both of their mounting fasteners.

### SUMMARY OF INVENTION

### Technical Problem

There are some objects that are used every day and that need to be kept easily accessible, one of which is keys. Keys are commonly kept on a hook or in a dish near the door. Hooks can be conveniently placed on the wall next to an entrance but are generally unsightly and require a certain amount of care while installing or removing objects. Dishes, on the other hand can have keys tossed into them without great thought, but if there happen to be more than one set of keys in the dish, extracting the right set may be difficult. Neither of these methods can hold flat objects such as cellphones and other electrical devices which are rarely designed with such mating features.

### Solution to Problem

In accordance with one embodiment, the user creates a void in a surface of a material which will be used to mount an object. The user then inserts a hollow insert into the void, followed by the forcible insertion of a magnet into the insert. The void, magnet and hollow insert are to be all properly sized such that an outer surface of the magnet pushes against inner surfaces of the hollow insert's walls which in turn press against the material surrounding the void. This interaction between the magnet, insert, and material allow for the secure installation of the magnet in such a way that does not require any precise tools and also allows for the magnet to be installed in a very wide range of materials.

### Advantageous Effects of Invention

The installed magnet can then be used to removably mount appropriately sized objects that are sufficiently attracted by its magnetic field.

### BRIEF DESCRIPTION OF DRAWINGS

Each drawing shows only an embodiment of the invention and should not be interpreted as a definitive or limiting explanation its design.

FIG. 1A—Exploded view of an embodiment of the invention showing the installation order of the magnet and the hollow insert into the void in the material.

FIG. 1B—Exploded view of an embodiment of the invention showing the object being mounted onto the installed magnet.

FIG. 1C—Isometric view of an embodiment of the invention showing the object mounted on the installed magnet.

FIG. 1D—Cross-section of an embodiment of the invention showing the installation of the hollow insert as well as its features.

FIG. 1E—Cross-section of an embodiment of the invention showing the installation of the magnet as well as its features.

FIG. 1F—Cross-section of an embodiment of the invention showing the installed magnet and the interaction between the magnets outer surfaces and the walls inner surfaces as well as the interaction between the outer surfaces of the walls and the material surrounding the void.

FIG. 2A—Exploded view of an embodiment of the invention showing the installation order of the magnet and the restraining material.

FIG. 2B—Exploded view of an embodiment of the invention showing the object being mounted onto the front face of the restraining material in the vicinity of the installed magnet.

FIG. 2C—Isometric view of an embodiment of the invention showing the object mounted on the front face of the restraining material.

FIG. 2D—Cross-section of an embodiment of the invention showing the magnet being installed into the void in the material.

FIG. 2E—Cross-section of an embodiment of the invention showing the installation of the restraining material using double sided adhesive.

FIG. 2F—Cross-section of an embodiment of the invention showing the completed installation of the magnet and the restraining material.

FIG. 3A—Exploded view of an embodiment of the invention showing the installation of the magnet that will be held in place using the filler material.

FIG. 3B—View of an embodiment of the invention showing the embedded magnet once it has been covered with the filler material and concealed.

FIG. 3C—Cross-section of material showing the magnet being installed into the void in the material.

FIG. 3D—Cross-section of material showing the installed magnet, held in place and concealed using the filler material.

FIG. 3E—Detail view showing the magnet recessed behind the surface of the material and being held in place using the filler material.

FIG. 4A—Exploded view showing the assembly process of installing the magnetically responsive tag onto the object using double sided adhesive.

FIG. 4B—Exploded view showing the non-magnetic object being mounted on a wall of material that has a magnet installed in its surface by means of the hollow insert.

FIG. 4C—Cross-section of material showing the object mounted against the installed magnet with the aid of an embodiment of the magnetically responsive tag.

FIG. 4D—Detail view showing an embodiment of the magnetically responsive tag and all of its features.

FIG. 5A—Exploded view showing the assembly process of installing an embodiment of the magnetically responsive tag comprising an embodiment of the locking feature onto the object using double sided adhesive.

FIG. 5B—Exploded view showing an embodiment of the object being mounted on a wall of material that has a magnet installed in its surface by means of the hollow insert.

FIG. 5C—Cross-section of material showing an embodiment of the object mounted against the installed magnet with the aid of an embodiment of the magnetically responsive tag.

FIG. 5D—Detail view showing an embodiment of the magnetically responsive tag comprising and embodiment of the mating surface and its features.

FIG. 5E—Cross-section of material showing an embodiment of the object being mounted against the installed magnet with the aid of an embodiment of the magnetically responsive tag and its features.

FIG. 5F—Detail view showing the engagement between an embodiment of the mating surfaces on the magnetically responsive tag and an embodiment of the flange on the hollow insert.

FIG. 6A—Exploded view showing the installation order of embodiments of the magnets installed by means of filler material and two different embodiments of the engagement article. The engagement articles being affixed by means of double sided adhesive.

FIG. 6B—Exploded view of an embodiment of the design showing the assembly process of installing the magnetically responsive tag onto the object using double sided adhesive.

FIG. 6C—Isometric view of an embodiment of the invention showing the installed magnetically responsive tag on the object.

FIG. 6D—Exploded view of an embodiment of the invention showing objects with magnetically responsive tags being mounted on a surface with installed magnets.

FIG. 6E—Isometric view of an embodiment of the invention showing the object being mounted at different angle against the installed magnets and engagement articles.

FIG. 6F—Detail view of an embodiment of the invention showing the mating surface of the engagement article.

FIG. 7A—Exploded view of an embodiment of the design showing the installation order for a magnet being affixed by means of the restraining piece of material and an engagement article being affixed by means of double sided adhesive.

FIG. 7B—Exploded view of an embodiment of the design showing the installation of the magnetically responsive tag onto the object by means of double sided adhesive.

FIG. 7C—Exploded view of an embodiment of the design showing the mounting of the object onto the restraining piece of material with the engagement article installed.

FIG. 7D—Cross section of an embodiment of the design showing the mounting of the object with the installed magnetically responsive tag into the engagement article installed onto the restraining material.

FIG. 7E—Detail view of an embodiment of the design showing the features of the engagement article and the magnetically responsive tag.

FIG. 7F—Cross section of an embodiment of the design showing the mounted object with the installed magnetically responsive tag mating with the engagement article installed onto the restraining material.

FIG. 7G—Detail view of an embodiment of the design showing the interaction between the magnetically responsive tag and the engagement article.

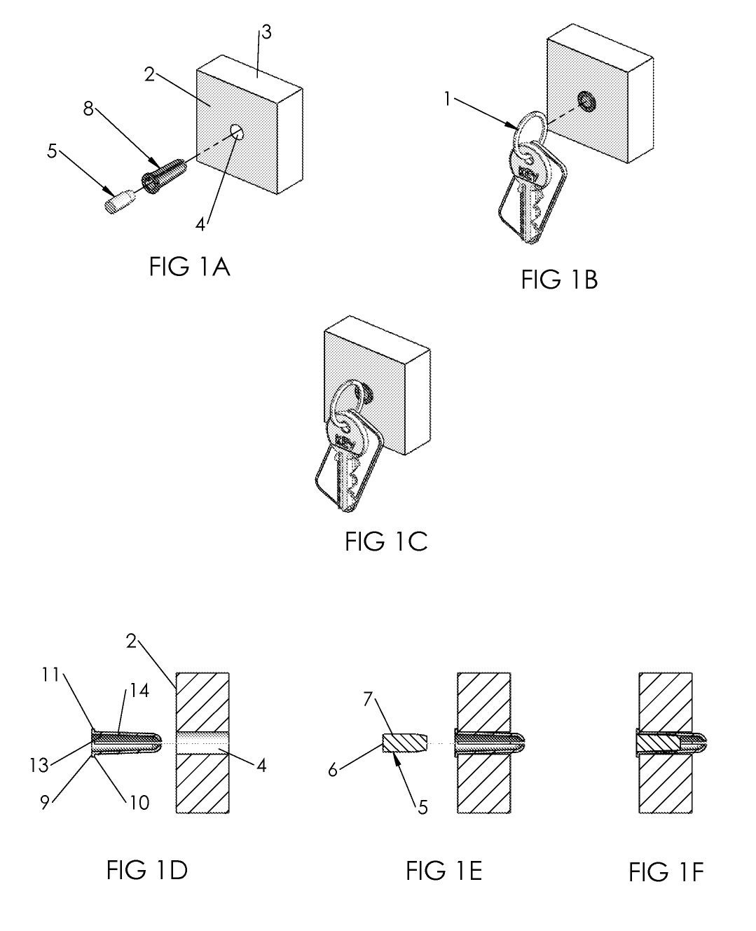

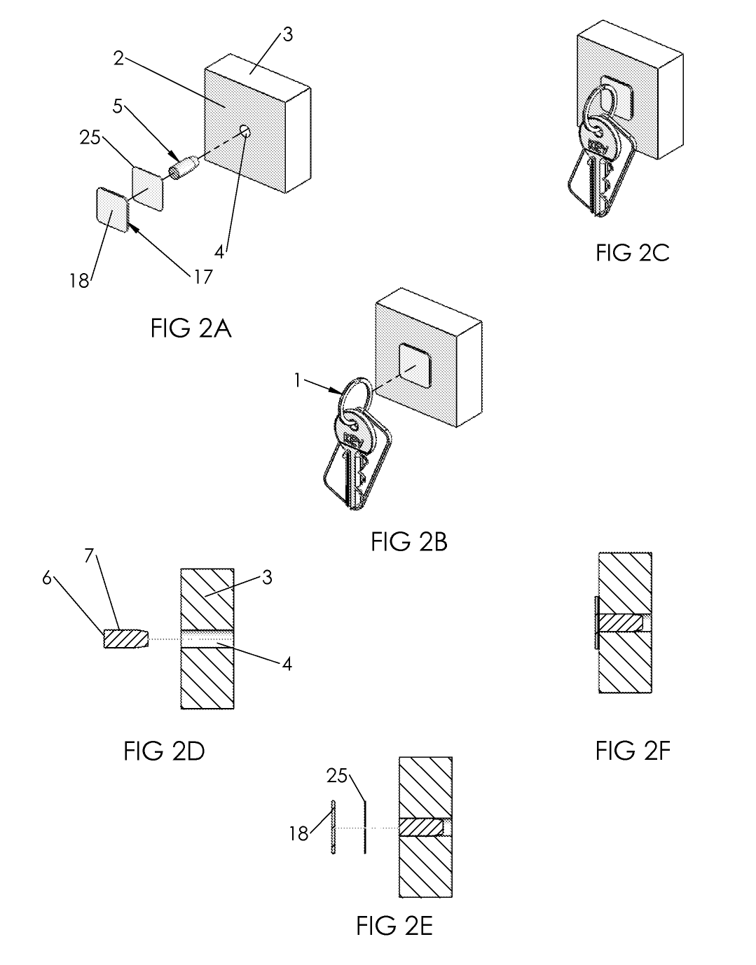

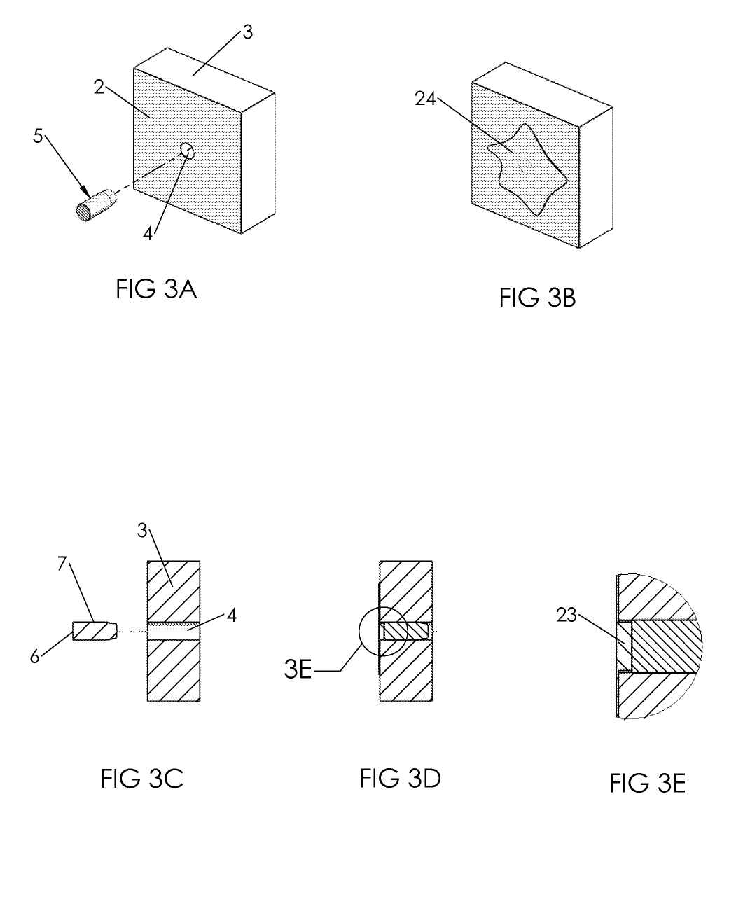

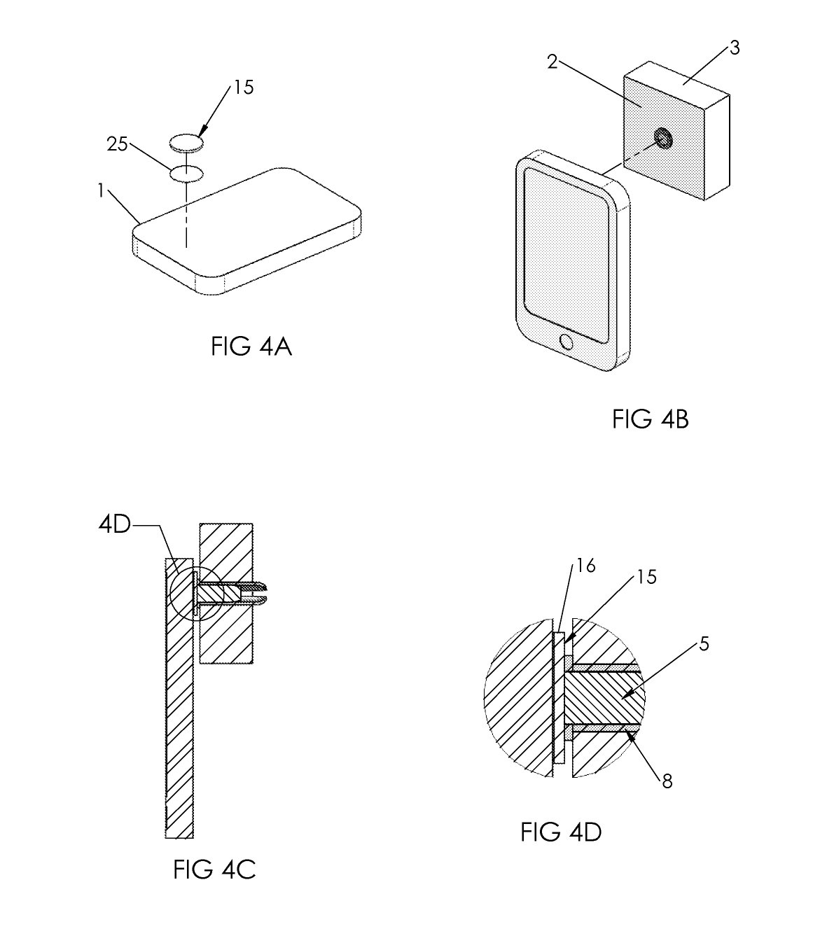

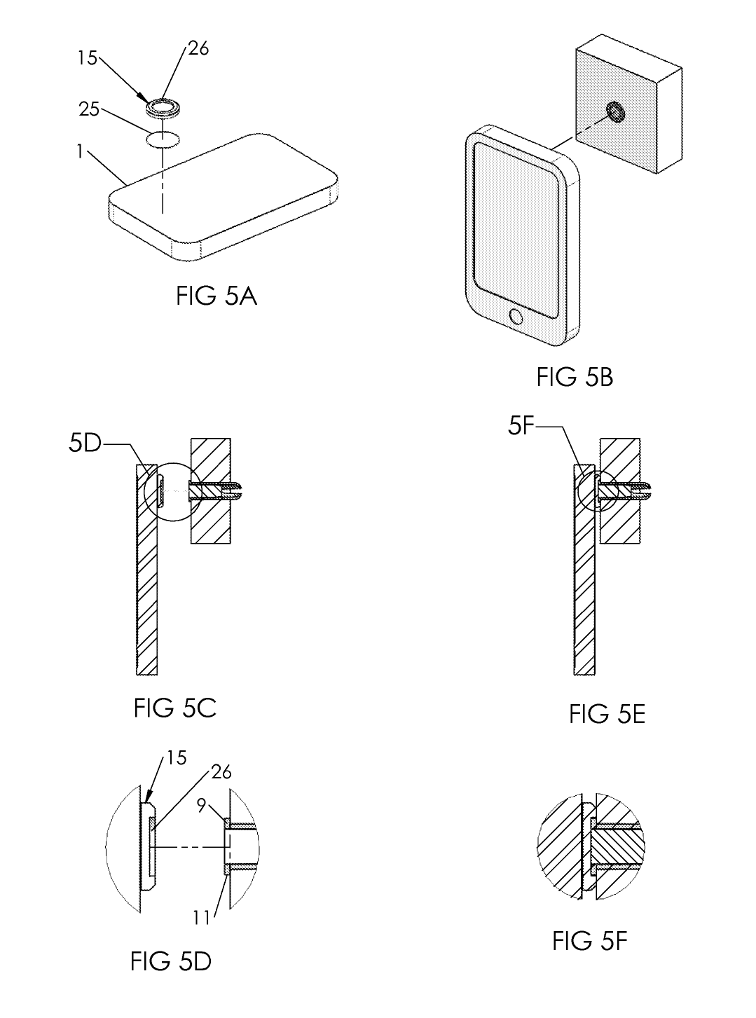

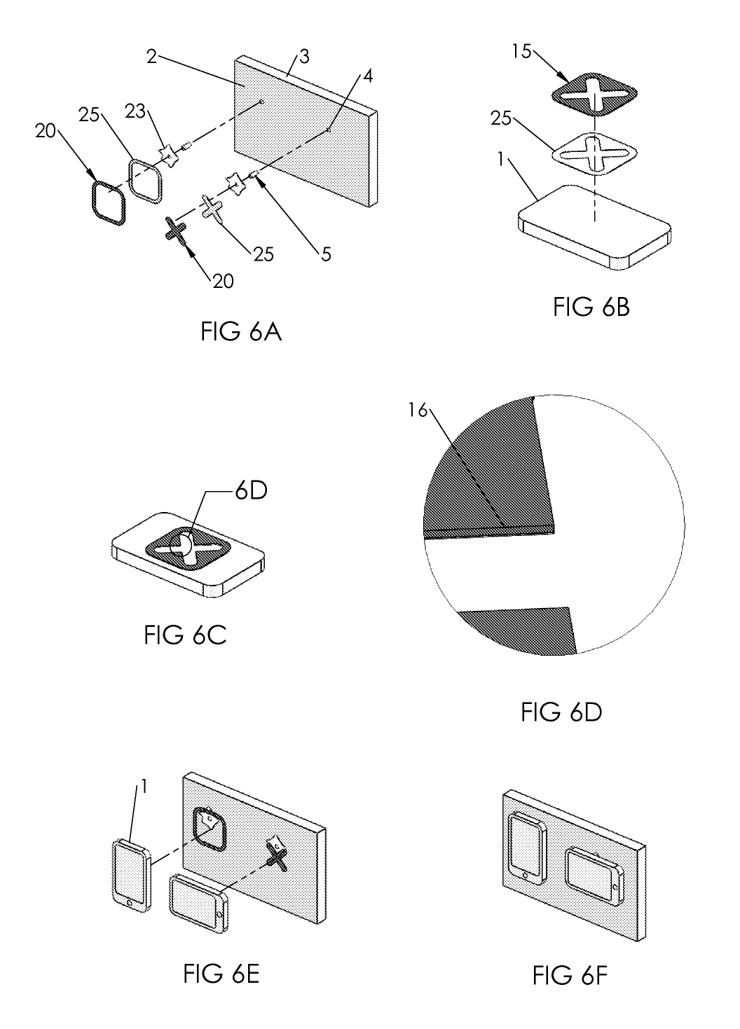

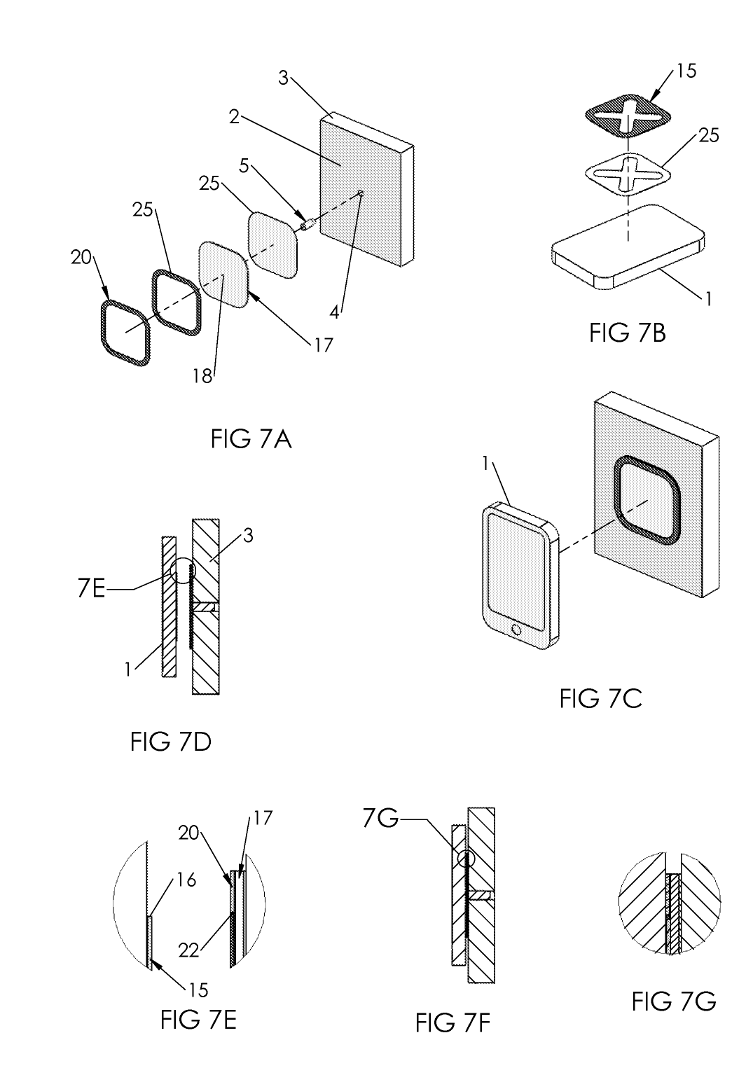

### DESCRIPTION OF EMBODIMENTS

### Example 1

The first embodiment of the design uses an appropriately sized hole, into which a hollow insert is inserted, followed by the forcible insertion of a cylindrical magnet. The components are designed such that the insertion of the magnet causes the walls of the insert to expand into the surrounding material. The contact forces created by this interference securely hold the magnet in place and prevent it from becoming dislodged during operation.

Once installed, the magnet can be used to removably mount objects of appropriate size, shape, weight, and magnetism.

### Example 2

Another embodiment of the design uses the hollow insert to affix the magnet into the wall but includes a magnetically responsive tag, which is attached to the object. According to the embodiment shown, double sided adhesive is used to attach the tag to the object.

Once the tag is installed onto the object, the object can be mounted onto the installed magnet by placing the object against the surface such that its tag lines up with the magnet, thereby increasing the attraction between the object and the magnet.

### Example 3

Another embodiment of the design uses the hollow insert to affix the magnet into the wall and a magnetically responsive tag to increase their attraction, but in this iteration, the tag comprises a cylindrical feature that engages the flange of the hollow insert.

The object can be mounted onto the installed magnet by placing the object against the surface such that the mating feature on the tag lines up with the flange located on the hollow insert. The magnetism attracts the object to the surface and the mating surfaces of the tag and the insert's flange prevent it from sliding off.

### Example 4

Another embodiment of the design uses an appropriately sized hole, a magnet, and a restraining piece of material. The magnet is inserted into the hole and the piece of material is affixed to the wall over the void using double sided adhesive.

The object can then be mounted on the exposed surface of the rigid piece of material by placing it in the vicinity of the installed magnet. When the object is removed, the piece of material remains attached to the surface and prevents the magnet from being pulled out during the removal of the mounted object.

### Example 5

Another embodiment of the design affixes the magnet into the wall using the restraining piece of material, but adds a magnetically responsive tag to the object and an engagement article to the exposed surface of the restraining piece of material. The tag and the article are design with compatible features such that the tag fits inside the engagement article.

The object can then be mounted by placing it up against the restraining piece of material such that it's installed tag fits with the engagement article. The installed magnet will attract the tag towards the surface and the tag's interaction with the engagement article will prevent it from accidentally sliding off.

### Example 6

Another embodiment of the design uses a hole in the surface of the material, a magnet, and a filler material. The magnet is inserted into the hole such that its front surface is recessed slightly behind the surface of the material. The filler material is then applied over the embedded magnet and allowed to dry. The filler material can then be sanded and painted over in order to completely conceal the magnet.

The object can then be mounted by placing it against the surface in the vicinity of the installed magnet, thereby appearing to float on the wall.

### Example 7

Another embodiment of the design uses the magnet installed in a hole with filler material, but adds a magnetically responsive tag to the object and an engagement article to surface of the material near the installed magnet. The tag and the article are design with compatible features such that the tag fits inside the engagement article.

The object can then be mounted by placing it up against the surface such that it's installed tag fits with the engagement article. The installed magnet will attract the tag towards the surface and the tag's interaction with the engagement article will prevent it from accidentally sliding off.

### INDUSTRIAL APPLICABILITY

Embodiments of the invention can be used to removably mount tools, hold objects together, or act as a means of triggering electromagnetic sensors.

### CITATION LIST

### Patent Literature

U.S. Pat. No. 3,022,701—Plastic Anchor-Type Fastener and Driver

### Non Patent Literature

Suck UK—Magnetic Keyholder

Umbra—Magnetter Wall Mount Organizer

I claim the following:

1. A method of removably mounting at least one object of a predetermined size, shape, weight, and magnetism to a surface of a material comprising:
a) providing a void of predetermined size and shape into said surface of said material,
b) providing a magnet having at least one front face and at least outer surface and of a predetermined size and shape such that it fits inside said void,
c) affixing said magnet into said void such that it remains in place during operation, and
d) mounting said object on said surface of said wall in close proximity to said magnet,
whereby said object is conveniently mounted on said surface and can be easily located, removed, and replaced as often as necessary.

2. The method of claim 1 wherein said magnet is affixed using a method comprising
a) inserting a hollow insert comprising a flange and at least one wall, the flange having a rear surface and at least one surface on its perimeter, each wall having an inner and an outer surface of predetermined size and shape such that it fits into said void and
b) inserting said magnet into said hollow insert such that its outer surfaces frictionally engage the inner surfaces of the walls and the outer surfaces of the walls frictionally engage the material surrounding the void,
whereby the magnet is held in place and prevented from becoming dislodged during operation.

3. The method of claim 2 further comprising
a) providing a magnetically responsive tag having at least one surface on its perimeter,
b) affixing said magnetically responsive tag to said object, and
c) mounting said object against said surface such that the attached tag lines up with the installed magnet,
whereby the object's magnetism is increased and its mounting more secure.

4. The method of claim 3 further comprising
a) providing at least one mating surface on the tag and
b) mounting said object against said surface such that the mating surface on the tag interfaces with the surface on the perimeter of said flange,
whereby the object is held more securely in the presence of side loading.

5. The method of claim 1 wherein said magnet is affixed using a method comprising
a) providing a restraining piece of material having a front surface and a rear surface and
b) affixing said restraining piece of material to said surface of said material such that the front surface of said magnet is at least partially covered,
whereby the magnet is held in place and prevented from becoming dislodged during operation.

6. The method of claim 5 further comprising
a) providing a magnetically responsive tag having at least one surface on its perimeter,
b) affixing said magnetically responsive tag to said object, and
c) mounting said object against said surface such that the attached tag lines up with the installed magnet,
whereby the object's magnetism is increased and its mounting more secure.

7. The method of claim 6 further comprising
a) providing an engagement article having a rear surface and at least one mating surface suitable for engaging the perimeter of said magnetically responsive tag,
b) affixing said engagement article to said front surface of said restraining piece of material, and
c) mounting the object on the front surface of the restraining material such the perimeter surfaces of the installed magnetically responsive tag engage the mating surfaces on the engagement article,
whereby the object is held more securely in the presence of side loading.

8. The method of claim 1 wherein said magnet is affixed by a method comprising
a) inserting said magnet into said void,
b) applying a filler material in flowable state into the hole, and
c) allowing the filler material to set, and
d) concealing the installed magnet by way of a surface preparation,
whereby the magnet is held in place and prevented from becoming dislodged during operation while the mounted object appears to float on the surface of the material.

9. The method of claim 8 further comprising
a) providing a magnetically responsive tag having at least on surface on its perimeter,
b) affixing said magnetically responsive tag to said object, and
c) mounting said object against said surface such that the attached tag lines up with the installed magnet,
whereby the object's magnetism is increased and its mounting more secure.

10. The method of claim 9 further comprising
a) providing an engagement article having a rear surface and at least one mating surface suitable for engaging the perimeter of said magnetically responsive tag,
b) affixing said engagement article to said surface in the vicinity of the embedded magnet, and
c) mounting said object against said surface such that the surfaces on the perimeter of the tag engage the mating surfaces on the engagement article,
whereby the object is held more securely in the presence of side loading.

11. A mounting system for mounting at least one object of a predetermined size, shape, weight, and magnetism to a surface of a material comprising
a void of predetermined size and shape in said surface of said material,
a magnet of a predetermined size and shape such that it fits inside said void, having at least one front face and an outer surface along its depth, and
a means of affixing said magnet into said hole
such that said object can be conveniently held up by the magnetic force of the magnet and can be easily located, removed, and replaced as often as necessary.

12. The mounting system of claim 11 wherein the means of affixing said magnet into said hole comprises
a hollow insert comprising a flange and at least one wall, the flange having a rear surface and at least one surface on its perimeter, each wall having an inner and an outer surface of predetermined size and shape such that when inserted into said void, the subsequent insertion of said magnet causes the outer surfaces of the magnet to frictionally engage the inner surfaces of the walls and the outer surfaces of the walls frictionally engage the material surrounding the void
such that the magnet is held in place and prevented from becoming dislodged during operation.

13. The mounting system of claim 12 further comprising
a magnetically responsive tag having at least one surface on its perimeter and
a means for attaching said magnetically responsive tag to said object
such that the object's magnetism is increased and its mounting more secure.

14. The mounting system of claim 13 wherein said magnetically responsive tag further comprises
at least one mating surface that engages said outer surface of said flange
such that the object is held more securely in the presence of side loading.

15. The mounting system of claim 10 wherein the means of affixing said magnet into said hole comprises
a restraining piece of material having a front surface and a back surface, and
a means for affixing said restraining piece of material to said surface of said material such that the front surface of said magnet is at least partially covered,
such that the magnet is held in place and prevented from becoming dislodged during operation.

16. The mounting system of claim 15 further comprising
a magnetically responsive tag having at least one surface on its perimeter and
a means for affixing said magnetically responsive tag to said object
such that the object's magnetism is increased and its mounting more secure.

17. The mounting system of claim 16 further comprising
an engagement article having at least one mating surface suitable for engaging the perimeter of said magnetically responsive tag and
a means for affixing said engagement article to said piece of restraining material
such that the object is held more securely in the presence of side loading.

18. The mounting system of claim 10 wherein the means of affixing said magnet into said hole comprises a filler material applied over the material and into said void such that said magnet is concealed and prevented from becoming dislodged during operation and the mounted object appears to be floating on the surface of the material.

19. The mounting system of claim 18 further comprising
a magnetically responsive tag having a front surface and at least one perimeter surface and
a means for attaching the said tag to said object
such that the object's magnetism is increased its mounting more secure.

20. The mounting system of claim 19 further comprising
an engagement article having a rear surface and at least one mating surface suitable for engaging the perimeter surface of said magnetically responsive tag and
a means for affixing said engagement article to said surface in the vicinity of the embedded magnet
such that the object is held more securely in the presence of side loading.
